(19) United States
(12) Patent Application Publication
(10) Pub. No.: US 2026/0106424 A1
(43) Pub. Date: Apr. 16, 2026

(54) ADAPTERS AND METHODS OF USE THEREOF FOR CONNECTING CABLE TERMINALS TO A HIGH-VOLTAGE CONNECTOR

(71) Applicant: VOLVO TRUCK CORPORATION, Göteborg (SE)

(72) Inventor: Chad OLMSTED, Greensboro, NC (US)

(73) Assignee: VOLVO TRUCK CORPORATION, Göteborg (SE)

(21) Appl. No.: 18/912,096

(22) Filed: Oct. 10, 2024

(51) Int. Cl. H01R 43/26

(52) U.S. Cl. CPC H01R 43/26; H01R 2201/26

(57) ABSTRACT

A removable adapter is configured to assist in connecting each cable terminal of a set of cable terminals to a connector. The adapter has a connector support surface configured to support a first portion of the connector when first and second portions of the connector are positioned on opposite sides of the connector support surface. The adapter has a cable terminal stopper for each cable terminal, the cable terminal stopper being configured to abut the cable terminal during connection of the cable terminal to the second portion of the connector such that the cable terminal assumes a predetermined orientation with respect to the connector support surface when connected to the second portion of the connector.

### TECHNICAL FIELD

The disclosure relates generally to a removable adapter configured to assist in connecting cable terminals of a set of cable terminals to a connector. The disclosure also relates to a removable stabilization adapter configured to assist in connecting cable terminals to the connector.

The disclosure can be applied in heavy-duty vehicles, such as trucks, buses, and construction equipment. Although the disclosure may be described with respect to a particular vehicle, the disclosure is not restricted to any particular vehicle.

### BACKGROUND

Connecting high-voltage components to one another for use in a certain application may be a challenge. For example, in electric vehicles, during vehicle assembly, there may be specific requirements for connecting high-voltage components to one another and for placement of the components in the vehicle. For example, in large electric vehicles, such as trucks, coupling a high-voltage connector and a cable terminal of a high-voltage cable, e.g., a battery cable, may require a certain orientation of the connector and the cable terminal with respect to one another. At the same time, the specific orientation may be challenging to achieve during a manual assembly of the components. Furthermore, during maintenance and repair, it may also be a challenge to connect a replacement cable terminal to the connector in the same orientation as a previously connected cable terminal, because again this depends on skills of a person connecting these components.

Accordingly, there is a need for improved methods and/or equipment for connecting cable terminals to connectors.

### SUMMARY

According to a first aspect of the disclosure, an adapter is provided that is configured to assist in connecting each cable terminal of a set of cable terminals to a connector, the connector comprising a first portion and a second portion. The adapter comprises a connector support surface configured to support the first portion of the connector when the adapter accommodates the connector such that the first and second portions of the connector are positioned on opposite sides of the connector support surface, the adapter being such that each cable terminal of the set of cable terminals can be connected to the second portion of the connector when the adapter accommodates the connector such that the first and second portions of the connector are positioned on opposite sides of the connector support surface.

The adapter also comprises a cable terminal stopper for each cable terminal of the set of cable terminals, the cable terminal stopper being configured to abut the cable terminal during connection of the cable terminal to the second portion of the connector such that the cable terminal assumes a predetermined orientation with respect to the connector support surface when connected to the second portion of the connector, and the adapter being such that it can be removed from each cable terminal of the set of cable terminals and the connector when each cable terminal of the set of cable terminals and the connector have been and remain connected together.

The first aspect of the disclosure may seek to provide the removable adapter that advantageously allows attaching cable terminals to the connector in a certain relationship to the connector, as required due to space constrains in an electric vehicle or in another environment. A technical benefit may include providing a tool or adapter that greatly facilitates a process of connecting each cable terminal of the set of cable terminals to the connector, such that by placing the components in contact with the adapter, due to a configuration of the adapter, a desired or required orientation of the components with respect to one another can be achieved. Accordingly, the connecting process is simplified and depends less on expertise of a person performing the process.

In some examples, the connector support surface may extend in a connector support surface plane having a connector support surface plane normal, wherein each cable terminal stopper comprises a cable terminal resting surface, the cable terminal resting surface being configured to abut the cable terminal during connection of the cable terminal to the second portion of the connector, the at least one cable terminal resting surface being located at a distance from the connector support surface in a direction parallel to the connector support surface plane normal, the at least one cable terminal resting surface extending in a cable terminal resting surface plane with a cable terminal resting surface plane normal, the cable terminal resting surface plane normal forming an angle with the connector support surface plane normal. A technical benefit may include that the at least one cable terminal resting surface may provide a useful part or implementation of the cable terminal stopper.

In some examples, each cable terminal of the set of cable terminals may be adapted to be connected to the second portion of the connector by means of a bolt joint when the first and second portions of the connector are positioned on opposite sides of the connector support surface.

In some examples, a portion of the bolt joint may be adapted to be rotated around an axis of rotation during the connection, wherein the cable terminal stopper of the adapter abuts the cable terminal such that the cable terminal assumes a predetermined rotation around the axis of rotation with respect to the connector support surface when connected to the second portion of the connector.

In some examples, the adapter in accordance with the first aspect of the disclosure may comprise at least one nut holder for each cable terminal of a set of cable terminals, the at least nut holder being adapted to hold a nut forming part of the bolt joint, before the first and second portions of the connector are positioned on opposite sides of the connector support surface. In other words, the nut may be placed to be held by the nut holder before the first and second portions of the connector are positioned on opposite sides of the connector support surface. A technical benefit may include that the adapter may hold the one or more nuts, which may facilitate an installation procedure.

According to a second aspect of the disclosure, a use of the adapter in accordance with the first aspect of the disclosure is provided for connecting each cable terminal of a set of cable terminals to a connector.

Advantages and effects of the use of the adapter are largely analogous to the advantages and effects of the adapter in accordance with the first aspect of the present disclosure. Further, all embodiments of the adapter are applicable to and combinable with all embodiments of the use of the adapter according to the examples herein, and vice versa.

According to a third aspect of the disclosure, a method is provided for connecting each cable terminal of a set of cable terminals to a connector using an adapter, the connector comprising a first portion and a second portion. The method comprises inserting the connector in the adapter whereby the first and second portions of the connector are located on opposite sides of a connector support surface of the adapter; for each cable terminal of the set of cable terminals, connecting the cable terminal to the second portion of the connector wherein a cable terminal stopper of the adapter abuts the cable terminal such that the cable terminal assumes a predetermined orientation with respect to the connector support surface when connected to the second portion of the connector; and removing the adapter from each cable terminal of the set of cable terminals and the connector when each cable terminal of a set of cable terminals and the connector have been and remain connected together.

In some examples, the method may comprise the following for each cable terminal of the set of cable terminals: connecting the cable terminal to the second portion of the connector by means of a bolt joint wherein a portion of the bolt joint is rotated around an axis of rotation during the connection, wherein the cable terminal stopper of the adapter abuts the cable terminal such that the cable terminal assumes a predetermined rotation around the axis of rotation with respect to the connector support surface when connected to the second portion of the connector.

Advantages and effects of the method in accordance with the third aspect of the disclosure are largely analogous to the advantages and effects of the adapter in accordance with the first aspect of the present disclosure. Further, all embodiments of the adapter are applicable to and combinable with all embodiments of the method for connecting each cable terminal of the set of cable terminals to the connector using the adapter, and vice versa.

According to a fourth aspect of the disclosure, a stabilization adapter is provided that is configured to assist in connecting at least one cable terminal of a set of cable terminals to a connector when the connector is attached to a body having a body surface, the connector comprising a first portion and a second portion located on opposite sides of the body surface whereby the second portion extends from the body surface. The stabilization adapter is adapted to at least partially accommodate the second portion of the connector and/or to contact at least a portion of the body surface. The stabilization adapter comprises a cable terminal stopper for the at least one cable terminal of the set of cable terminals, the cable terminal stopper being configured to abut the cable terminal during connection of the cable terminal to the second portion of the connector such that the cable terminal assumes a predetermined orientation with respect to the body surface when connected to the second portion of the connector. The stabilization adapter is being such that it can be removed from the at least one cable terminal of the set of cable terminals and the second portion of the connector when the at least one cable terminal of the set of cable terminals and the connector have been and remain connected together.

The fourth aspect of the disclosure may seek to provide the removable stabilization adapter that advantageously allows attaching cable terminals to the connector in a certain relationship to the connector, as required due to space constrains in an electric vehicle or in another environment. A technical benefit may include providing a tool or adapter that greatly facilitates a process of connecting each cable terminal of the set of cable terminals to the connector, such that by placing the components in contact with the adapter, due to a configuration of the adapter, a desired or required orientation of the components with respect to one another can be achieved. Accordingly, the connecting process depends less on expertise of a person performing the process. In this way, the maintenance and repair of the vehicle comprising the cable terminals and the connector may be simplified and made less error prone.

According to a fifth aspect of the disclosure, a use of the stabilization adapter in accordance with the fourth aspect of the disclosure is provided, for connecting at least one cable terminal of a set of cable terminals to a connector.

Advantages and effects of the use of the stabilization adapter are largely analogous to the advantages and effects of the stabilization adapter in accordance with the fourth aspect of the disclosure. Further, all embodiments of the stabilization adapter are applicable to and combinable with all embodiments of the use of the stabilization adapter for connecting at least one cable terminal of the set of cable terminals to the connector, and vice versa.

According to a sixth aspect of the disclosure, a method is provided for connecting at least one cable terminal of a set of cable terminals to a connector using a stabilization adapter, the connector being attached to a body having a body surface, the connector comprising a first portion and a second portion located on opposite sides of the body surface whereby the second portion extends from the body surface. The method comprises positioning the stabilization adapter whereby the stabilization adapter at least partially accommodates the second portion and/or contacts at least a portion of the body surface; for the at least one cable terminal of the set of cable terminals: connecting the at least one cable terminal to the second portion of the connector wherein a cable terminal stopper of the stabilization adapter abuts the at least one cable terminal such that the at least one cable terminal assumes a predetermined orientation with respect to the body surface when connected to the second portion of the connector; and removing the stabilization adapter from the at least one cable terminal of the set of cable terminals and the connector when the at least one cable terminal of the set of cable terminals and the connector have been and remain connected together.

Advantages and effects of the method in accordance with the sixth aspect of the disclosure are largely analogous to the advantages and effects of the stabilization adapter in accordance with the fourth aspect of the disclosure. Further, all embodiments of the stabilization adapter are applicable to and combinable with all embodiments of the method in accordance with the sixth aspect of the disclosure, and vice versa.

### BRIEF DESCRIPTION OF THE DRAWINGS

With reference to the appended drawings, below follows a more detailed description of aspects of the disclosure cited as examples.

FIGS. 1A and 1B are perspective views of an example of an environment in which an adapter in accordance with examples of the present disclosure may be used.

FIG. 2 is a perspective view of an example of an adapter in accordance with examples of the present disclosure.

FIGS. 3, 4, 5, 6, 7, and 8 are perspective views illustrating a method for connecting each cable terminal of a set of cable terminals to a connector using the adapter of FIG. 2, in accordance with examples of the present disclosure.

FIG. 9 is a perspective view of an example of a stabilization adapter in accordance with examples of the present disclosure.

FIGS. 10 and 11 are perspective views illustrating a method for connecting at least one cable terminal of a set of cable terminals to a connector using the stabilization adapter of FIG. 9, in accordance with examples of the present disclosure.

### DETAILED DESCRIPTION

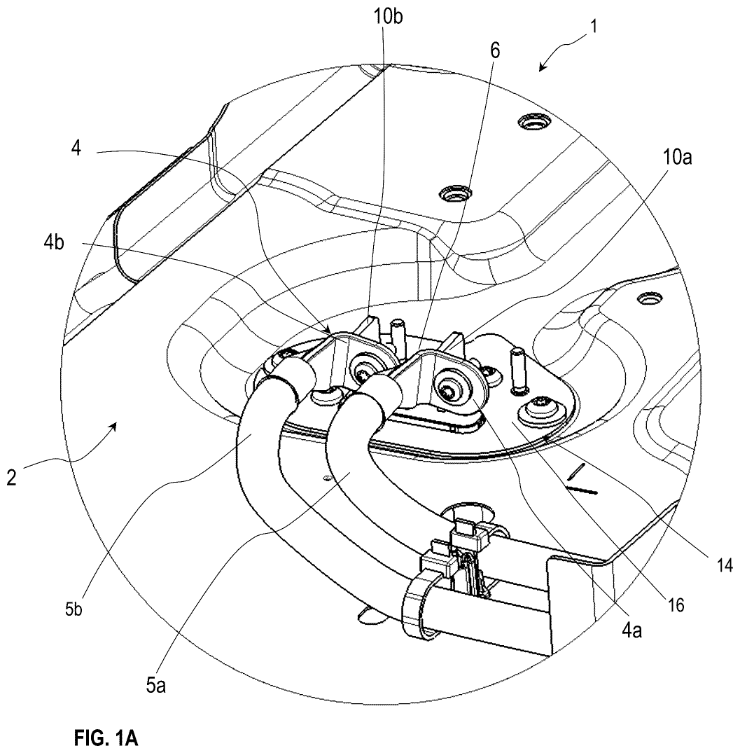

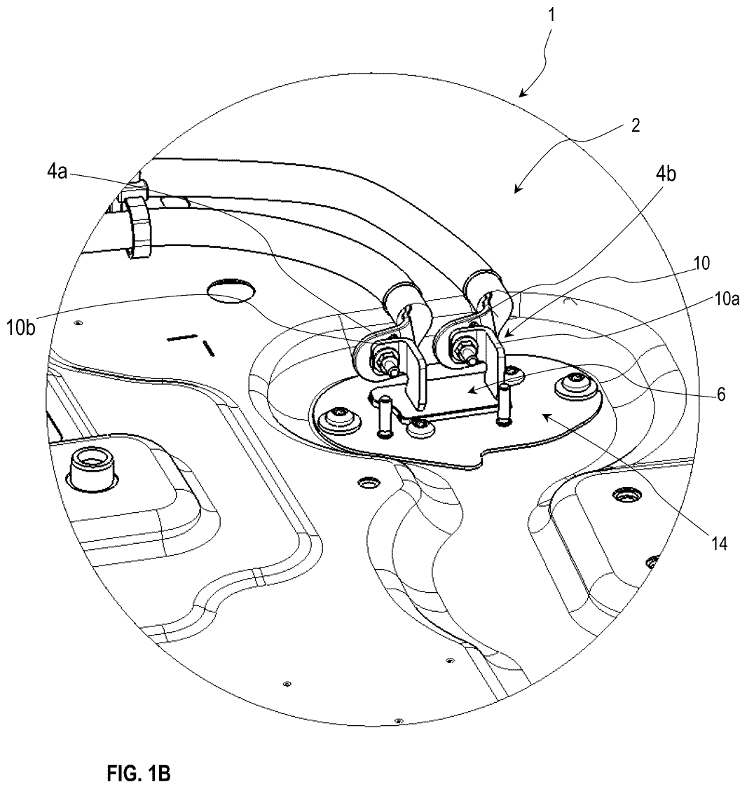

FIGS. 1A and 1B depict an example of an environment 1 in which an adapter in accordance with aspects and examples of the present disclosure may be used. The environment 1 may be, e.g., a floor 2 of an electric vehicle such as a truck. It should be appreciated that the floor 2 of the truck is shown as an example only, as the adapter in accordance with the present disclosure may be used in other locations in the vehicle, or in applications other than a vehicle.

FIGS. 1A and 1B do not show the adapter but they illustrate a complete assembly in which each cable terminal 4a, 4b of a set 4 of cable terminals connected to a connector 6 such as e.g. a high-voltage connector. In some examples, the connector 6 may be a PCON (Power Connector) connector. The cable terminals 4a, 4b and the connector 6 can be connected to one another using the adapter in accordance with the present disclosure.

In the example illustrated, the cable terminals 4a, 4b are coupled to respective cables 5a, 5b. The cables 5a, 5b may be high-voltage cables e.g. battery cables, though the cables may be for any other suitable components.

The connector 6 may comprise a first portion, which is obscured in FIGS. 1A and 1B, and a second portion 10 that is configured to be coupled or connected to the cable terminals 4a, 4b. The second portion 10 may comprise a mating end e.g. in the form of first and second brackets 10a, 10b. The connector 6 may be coupled to a body 14 having a body surface 16.

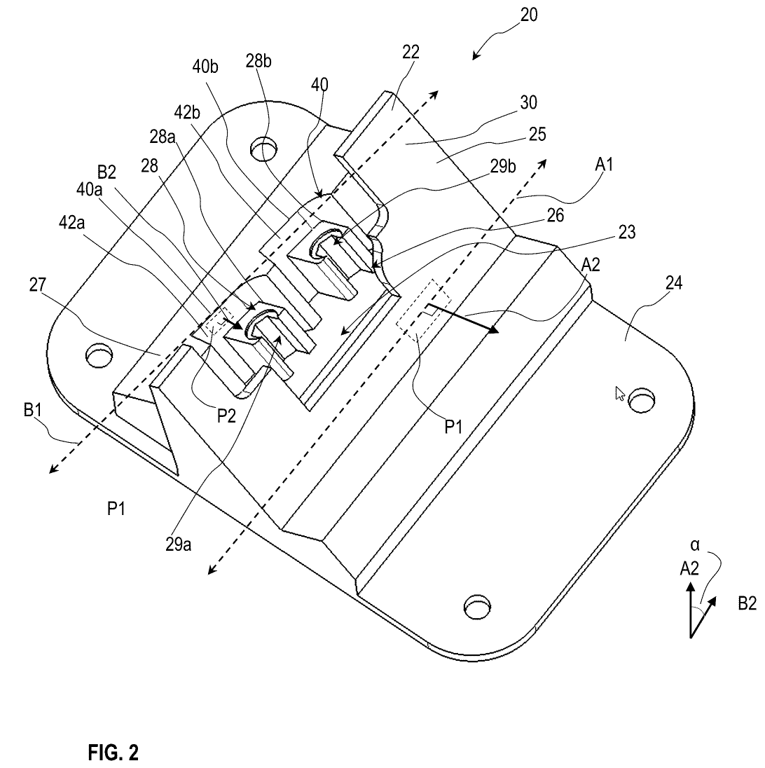

The connector 6 can be attached to the body 14 e.g. a plate or a bracket, prior to connecting the cable terminals 4a, 4b to the connector 6. The body 14 is not shown in FIGS. 2-8 for clarity of illustration, but it should be appreciated that the connector 6 may be attached to the body 14 before the cable terminals 4a, 4b and the connector 6 are connected. In some examples, the body may be a portion of the floor 2 and the connector may be coupled directly to the body comprising the floor 2 having a body surface that is a surface of the floor 2.

In some implementations of the vehicle, it may be required that the cables 5a, 5b be positioned in a specific way along the floor 2 such that the cable terminals 4a, 4b need to be oriented in a certain way relative to the connector 6. For example, the cables 5a, 5b may need to be passed between the floor 2 and a floor mat (not shown) positioned on the floor 2. The cable terminals 4a, 4b may need to be oriented with respect to the connector 6 under a certain required angle, e.g., 15 degrees in some implementation. If the cable terminals are oriented with respect to the connector at an angle larger than the required angle, the cables may bulge which may interfere with proper placement of the floor mat over the floor of the vehicle due to bulges or bumps created by the cable terminals sitting higher than required. On the other hand, orienting the cable terminals with respect to the connector at an angle that is smaller than the required angle may make it impossible to securely attach the cable terminals to the connector. It should be noted that various scenarios are possible, and the cable terminals and the connector may be coupled to one another at other locations of the vehicle, different from the floor. In any case, the adapter in accordance with examples of the present disclosure allows orienting the cable terminals at the desired or required angle relative to the connector and securing the cable terminals to the connector at this angle, in a straightforward manner that greatly facilitates the connecting process and does not require any other tools or instruments other than the adapter.

It should be appreciated that the present disclosure is not limited to any specific type of vehicle, and may be used for any other type of vehicle, such as a bus, construction equipment, e.g. a wheel loader or an excavator, a passenger car, an aircraft, an agricultural vehicle, a sports vehicle, and a marine vessel. The present disclosure is also applicable for other applications not relating to vehicles, including stationary applications.

FIG. 2 illustrates an example of an adapter 20 configured to assist in connecting each cable terminal 4a, 4b of a set of cable terminals 4 to the connector 6, the connector 6 comprising the first portion and the second portion. The adapter 20 may comprise an adapter body 22 that may be mounted on a base plate 24 which may have any suitable configurations. The base plate 24 may be an optional component.

The set of cable terminals 4 comprises first and second cable terminals 4a, 4b in the illustrated examples. It should be appreciated however that the set of cable terminals may comprise more than two cable terminals.

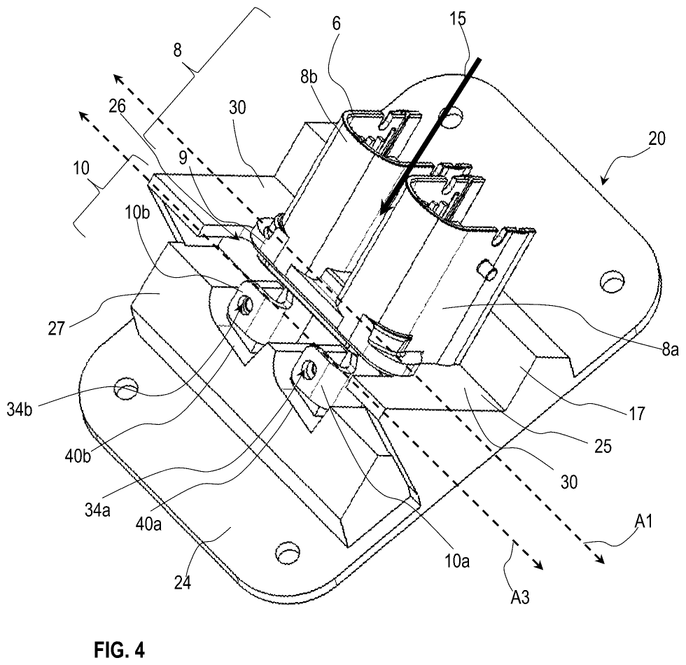

The adapter 20 e.g., the adapter body 22 comprises a connector support surface 30 configured to support the first portion of the connector 6 when the adapter 20 accommodates the connector 6 such that the first and second portions of the connector 6 are positioned on opposite sides of the connector support surface 30. The adapter 20 is configured such that each cable terminal 4a, 4b of the set of cable terminals 4 can be connected to the second portion of the connector 6 when the adapter 20 accommodates the connector 6 such that the first and second portions of the connector 6 are positioned on opposite sides of the connector support surface 30, as also shown below in FIG. 4.

As shown in FIG. 2, the connector support surface 30 may be formed in and by an outer surface of a first wall 25 of the adapter 20, wherein the first wall 25 comprises a through cutout 26, and wherein the connector support surface 30 is configured to seat the first portion of the connector 6 when the second portion of the connector 6 is inserted through the cutout 26 such that the first and second portions of the connector 6 are positioned on opposite sides of the first wall 25 and thus on the opposite sides of the connector support surface 30. The cutout 26 may be sized and shaped so as to be able to fit the second portion of the connector 6 therethrough while the first portion of the connector 6 is positioned on the opposite side of the connector support surface 30.

The adapter 20 e.g., the adapter body 22 also comprises a cable terminal stopper 40 for each cable terminal 4a, 4b of the set of cable terminals 4. Thus, as shown in FIG. 2, the cable terminal stopper 40 comprises first and second cable terminal stoppers 40a, 40b which may be in the form of respective surfaces. Each of the first and second cable terminal stoppers 40a, 40b is configured to abut the respective cable terminal 4a, 4b during connection of the cable terminal 4a, 4b to the second portion of the connector 6 such that the cable terminal 4a, 4b assumes a predetermined orientation with respect to the connector support surface 30 when connected to the second portion of the connector 6.

The adapter 20 may in some implementations comprise more than two cable terminal stoppers such that more than two cable terminals may be coupled to a connector using the adapter 20.

The adapter 20 is configured such that it can be removed from each cable terminal 4a, 4b of the set of cable terminals 4 and the connector 6 when each cable terminal 4a, 4b of the set of cable terminals 4 and the connector 6 have been and remain connected together.

The connector support surface 30 extends in a connector support surface plane P1 having a connector support surface plane normal A2, wherein each of the cable terminal stopper 40a, 40b comprises a cable terminal resting surface 42a, 42b, the cable terminal resting surface 42a, 42b being configured to abut the cable terminal 4a, 4b during connection of the cable terminal 4a, 4b to the second portion of the connector 6. Thus, the first cable terminal stopper 40a comprises a first cable terminal resting surface 42a, and the second cable terminal stopper 40b comprises a second terminal resting surface 42b.

As shown in FIG. 2, the at least one cable terminal resting surface 42a, 42b is located at a distance from the connector support surface 30 in a direction parallel to the connector support surface plane normal A2. The at least one cable terminal resting surface 42a, 42b may be formed in an inner surface of a second wall 27 of the adapter 20, the second wall 27 being spaced apart from the first wall 25. A slot or open space 23 may be formed between the first and second walls 25, 27 of the adapter 20, and the second portion of the connector 6 may be inserted through the cutout 26 to be positioned in the space 23.

The at least one cable terminal resting surface 42a, 42b extends in a cable terminal resting surface plane P2 with a cable terminal resting surface plane normal B2, the cable terminal resting surface plane normal B2 forming an angle α with the connector support surface plane normal A2. The angle α between the cable terminal resting surface plane normal B2 and the connector support surface plane normal A2 is schematically illustrated in the bottom right portion of FIG. 2. In FIG. 2, only the cable terminal resting surface plane P2 associated with one of the cable terminal resting surface 42a is illustrated for the sake of brevity. By way of example, the angle α between the cable terminal resting surface plane normal B2 and the connector support surface plane normal A2 corresponds to an angle between a plane of the at least one cable terminal resting surface 42a, 42b and a plane of the connector support surface 30.

An x-axis or a longitudinal direction A1 of the connector support surface plane is shown schematically in FIG. 2, wherein the connector support surface plane normal A2 is orthogonal to the longitudinal direction A1 of the connector support surface plane. An x-axis B1 or a longitudinal direction of the first cable terminal resting surface 42a is also schematically shown in FIG. 2, and the cable terminal resting surface plane normal B2 is orthogonal to the longitudinal direction B1 of the first cable terminal resting surface 42a.

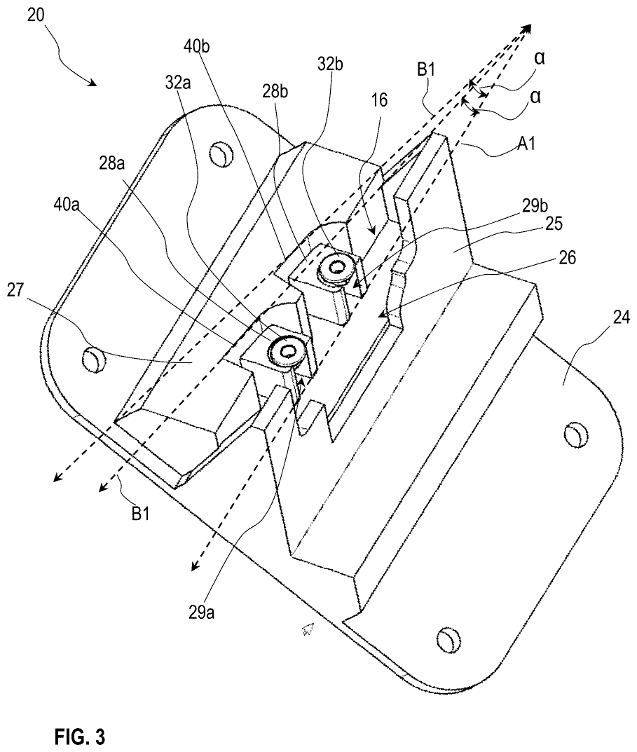

Thus, by way of example only and also with reference to FIG. 3, the longitudinal directions B1, A1 are shown to illustrate an angle α between the cable terminal resting surface plane and the connector support surface plane, wherein the angle α corresponds to the angle between the cable terminal and the second portion of the connector that is established when the cable terminal and the connector are attached to one another. Accordingly, the configuration of the adapter 20 and the orientation of the at least one cable terminal resting surface 42a, 42b relative to the connector support surface 30, allows aligning the cable terminals 4a, 4b at a predetermined orientation i.e. at the certain angle relative to the connector 6, and connecting the cable terminals 4a, 4b to the connector 6 at that angle. In this way, the first and second cables 5a, 5b coupled to the first and second cable terminals 4a, 4b can be positioned in a desired manner. The longitudinal directions B1, A1 are preferably selected such that the angle α between the longitudinal directions B1, A1 (see FIG. 3) corresponds to the angle between the connector support surface plane normal A2 and the cable terminal resting surface plane normal B2 (see FIG. 2).

The angle is an acute angle. In some examples, the angle may be a 15 degrees angle, though other angles are possible depending on the configuration of the adapter 20. In some examples, the angle may be smaller than 15 degrees or greater than 15 degrees. For example, the angle may be in a range of from 10 degrees to 20 degrees, depending on a configuration of the adapter 20.

In some examples, the adapter 20 may comprise at least one nut holder 28, e.g. in the form of first and second nut holders 28a, 28b for each cable terminal 4a, 4b of the set of cable terminals 4. Each of the first and second nut holders 28a, 28b may be adapted to hold a nut, forming part of a bolt joint as discussed in more detail below, before the first and second portions of the connector 6 are positioned on opposite sides of the connector support surface 30. Each of the first and second nut holders 28a, 28b may comprise a respective first and second open-sided longitudinal groove or bore 29a, 29b, respectively, wherein the longitudinal groove or bore 29a, 29b is configured to removably receive a nut therein. As shown in FIG. 2, the first and second longitudinal bores 29a, 29b face the cutout 26 in the first wall 25 of the adapter 20. The first and second longitudinal bores 29a, 29b may be sized and shaped to receive the nut therein. For example, as shown in FIG. 2, inner walls of the bores 29a, 29b may have features e.g. longitudinal ribs or any other features that assist in removably positioning the nut in the bore.

The nut holder 28 may have any suitable shape and size, and it is configured to temporarily hold a nut 32a (see FIG. 3) that receives a bolt therein to form the bolt joint whereby the cable terminal is attached to the second portion of the connector. Moreover, by way of example only, the nut holder 28 may be adapted to engage by a nut 32a (see FIG. 3) such that rotation of the nut relative the nut holder is prevented when a bolt (not shown in FIG. 2) is inserted into the nut by means of a rotation of the bolt relative to the nut. Purely by way of example, the nut holder may have one or more abutments surfaces adapted to abut one or more abutment surfaces of the nut when the nut 32a is inserted into the nut holder 28.

The adapter 20 may be made from any suitable material and it is sufficiently rigid to perform the stabilization function. Parts of the adapter 20 may be monolithically and/or integrally formed with one another. In some examples, the adapter 20 may be made by injection molding from a suitable polymer material. In some examples, the adapter 20 may be made from a metal or any other suitable material.

FIGS. 3-8 illustrate a method for connecting each cable terminal 4a, 4b of the set of cable terminals 4 to the connector 6 using the adapter 20. The connector 6 comprises a first portion 8 and the second portion 10 as shown in FIG. 4. The description of the adapter 20 in connection with FIG. 2 applies to FIGS. 3-8, and not all elements are therefore labeled in FIGS. 3-8. In some examples, prior to connecting the cable terminals to the connector 6 using the adapter 20, the connector 6 may be attached to the body 14 having the body surface 16 such that the first portion 8 and the second portion 10 are located on opposite sides of the body surface 16 and whereby the second portion 10 extends from the body surface 16.

FIG. 3 illustrates that the method comprises inserting a nut in the least one nut holder, such as inserting a first nut 32a in the bore 29a of the first nut holder 28a and inserting a second nut 32b in the bore 29b of the second nut holder 28b. The first and second nuts 32a, 32b have respective through holes formed therein, wherein at least a portion of an inner walls of the holes may be threaded.

FIG. 3 additionally illustrates that each of the first and second cable terminal resting surfaces 42a, 42b extends in the cable terminal resting surface plane with the longitudinal direction B1, and an axis indicating the longitudinal direction B1 forms an angle α with an axis indicating the longitudinal direction A1 of the connector support surface plane of the connector support surface 30. It should be noted, as indicated in FIG. 3, that the axes indicating the longitudinal direction B1 of the respective planes of both of the first and second cable terminal resting surfaces 42a, 42b each form the same angle α with the axis indicating the longitudinal direction A1 of the connector support surface plane, even though this may not be apparent from the present Figures. In some examples, the angle α may be 15 degrees.

FIG. 4 illustrates that the method further comprises inserting the connector 6 in the adapter 20 whereby the first and second portions 8, 10 of the connector 6 are located on opposite sides of the connector support surface 30 of the adapter 20. Positioning the first and second portions of the connector 6 relative to the connector support surface 30 as shown in FIG. 4 causes a plane of a surface of at least the second portion 10 of the connector 6 to be parallel to the connector support surface plane of the connector support surface 30. FIG. 4 shows schematically an axis A3 indicating a longitudinal direction of a plane passing through the top surfaces of the first and second mating ends 10a, 10b, wherein the plane passing through the top surfaces of the first and second mating ends 10a, 10b is parallel to the connector support surface plane.

The connector 6 can be slidably received in the adapter 20, in a direction shown by an arrow 15, through the cutout 26 in the first wall 25 of the adapter 20 such that the first portion 8 of the connector 6 remains on the side of the connector support surface 30 whereas the second portion 10 is positioned in the space 23, on the opposite side of the first wall 25 and the connector support surface 30. In some implementations, as in the illustrated example, the adapter 20 may comprise an additional support surface 17 configured to seat a part of the first portion 8 of the adapter 20. The additional support surface 17 extends in an additional support surface plane that may in some cases be orthogonal to the connector support surface plane of the connector support surface 30. It should be appreciated however that other configurations are possible.

FIG. 4 shows that the first portion 8 of the connector 6 may comprise a first housing 8a and a second housing 8a, though it should be appreciated that the first portion 8 may have various other configurations as examples of the present disclosure are not limited in this respect. The second portion 10 of the connector may comprise a first mating end 10a and a second mating end 10b configured to be fixedly connected to the first and second cable terminals 4a, 4b, respectively. The first and second mating ends 10a, 10b may be in the form of brackets, though the second portion 10 may have various other configurations as examples of the present disclosure are not limited in this respect. The second portion 10 may also comprise a support surface or plate 9 positioned between the first portion 8 and the first and second mating ends 10a, 10b.

As shown in FIG. 4, when the connector 6 is inserted in the adapter 20 whereby the first and second portions 8, 10 of the connector are located on opposite sides of the connector support surface 30 of the adapter 20, the second portion 10 is positioned such that the first and second mating ends 10a, 10b of the second portion 10 are positioned over respective first and second nut holders 28a, 28b. The first and second mating ends 10a, 10b of the second portion 10 are positioned over top portions of the first and second nut holders 28a, 28b such that respective first and second openings 34a, 34b in the first and second mating ends 10a, 10b are aligned with the bores 29a, 29b in the first and second nut holders 28a, 28b. Although this is obscured in FIG. 4, the first and second nut holders 28a, 28b have respective first and second nuts 32a, 32b inserted therein in the bores 29a, 29b, respectively. In this way, the second portion 10, such that the first and second mating ends 10a, 10b of the second portion 10, are positioned for forming a connection with the first and second cable terminals 4a, 4b.

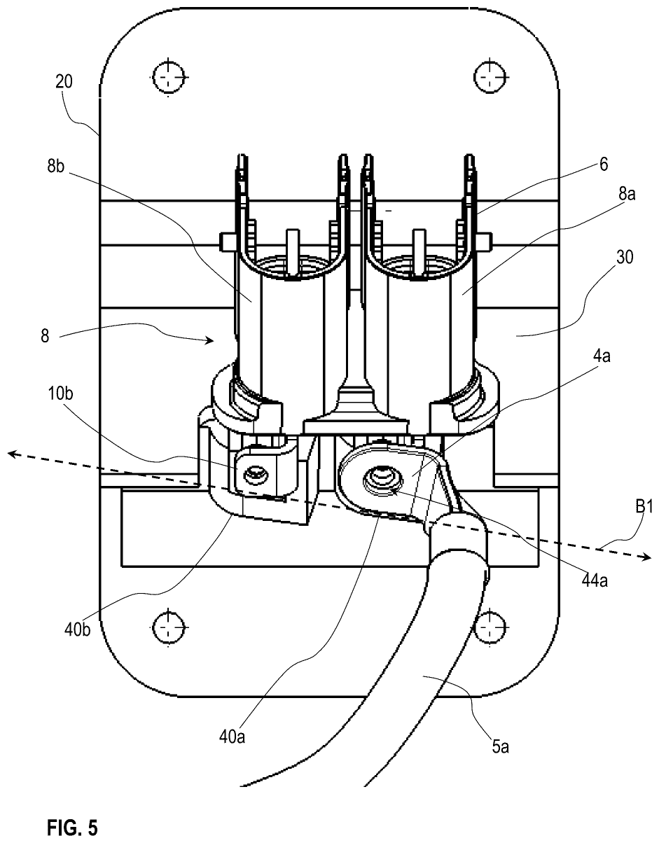

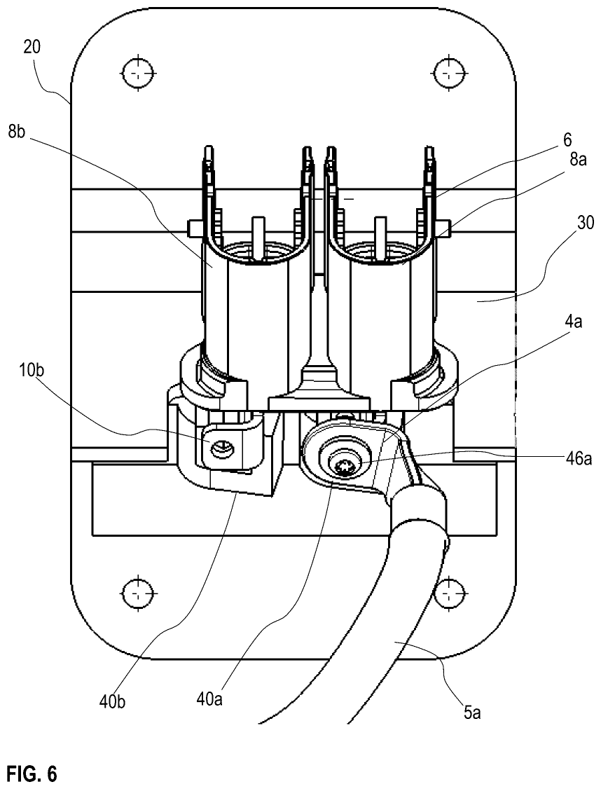

FIGS. 5 and 6 illustrate that the method comprises, for each cable terminal 4a, 4b of the set of cable terminals 4, with the first cable terminal 4a being shown as a representative cable terminal, connecting the cable terminal 4a, 4b to the second portion 10 of the connector 6 wherein the cable terminal stopper 40a, 40b of the adapter 20 abuts the cable terminal 4a, 4b such that the cable terminal 4a, 4b assumes a predetermined orientation with respect to the connector support surface 30 when connected to the second portion 10 of the connector 6. FIG. 5 shows that the first cable terminal 4a is rested or positioned such that the cable terminal stopper 40a of the adapter 20 abuts the first cable terminal 4a. Positioning the first cable terminal 4a such that the cable terminal stopper 40a of the adapter 20 abuts the first cable terminal 4a causes a longitudinal direction of the first cable terminal 4a coincide with the longitudinal direction B1 of the cable terminal resting surface plane, as shown schematically in FIG. 5. Accordingly, due to the use of the adapter 20, the first cable terminal 4a and at least the second portion 10 of the connector 6 are positioned such that an angle between their respective planes corresponds to, i.e. is the same, as the angle between the cable terminal resting surface plane and the connector support surface plane. Thus, the configuration of the adapter 20 allows establishing a desired or required orientation of the cable terminals 4a, 4b with respect to the second portion 10 of the connector 6. As used herein, substantially the same refers to an angle that deviates from a reference angle by no more than 1 degree.

The first mating end 10a of the second portion 10 of the connector 6 is positioned over a top portion of the first nut holder 28a, and the first cable terminal 4a, when supported by the cable terminal stopper 40a of the adapter 20, is positioned over the first mating end 10a of the second portion 10 of the connector 6.

The first cable terminal 4a has an opening 44a, which may be referred to as a first opening for consistency. When the first cable terminal 4a is positioned such that the cable terminal stopper 40a of the adapter 20 abuts the first cable terminal 4a, the first opening 44a in the first cable terminal 4a is aligned with the first opening 34a in the first mating end 10a of the connector 6 and with the first bore 29a in the first nut holder 28a wherein the first bore 29a has the first nut 32a inserted therein.

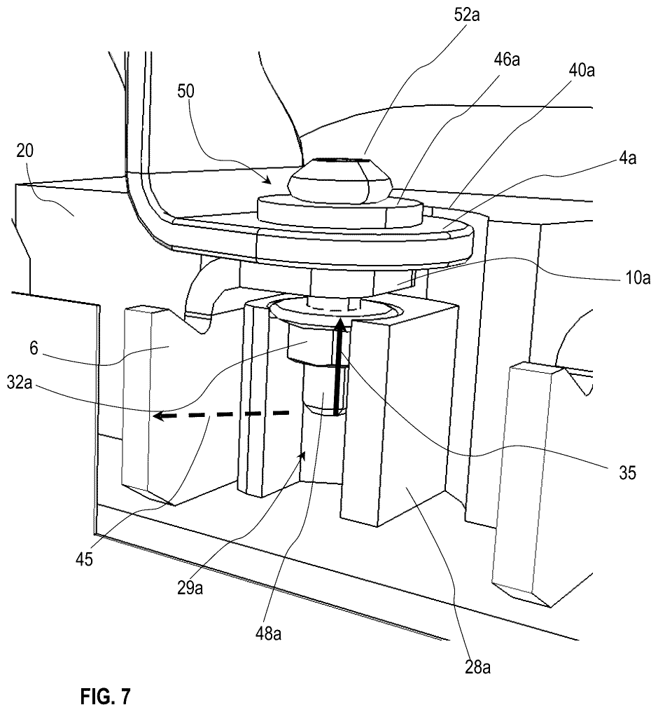

FIGS. 6 and 7 illustrate that a further step of the method in accordance with examples of the present disclosure may be to insert a fastener such as e.g. a first screw or bolt 46a through the first opening 44a in the first cable terminal 4a, wherein the first bolt 46a is also passed through the first opening 34a in the first mating end 10a of the second portion 10 of the connector 6 and is inserted into a hole in the first nut 32a seated in the first bore 29a. The first bolt 46a has a thread around at least a portion of an outer surface thereof, such that the threads of the first bolt 46a can fixedly engage with the thread in the inner surface of the through hole in the first nut 32a. As shown in FIG. 7, the first bolt 46a may comprise a shaft 48a and a head 52a. A bolt joint 50 may be formed as torque is applied to insert the first bolt 46a through the first nut 32a. An instrument or tool, e.g., a screwdriver may be used to torque down the first bolt 46a into the first nut 32a.

The method in accordance with examples of the present disclosure comprises connecting the cable terminal 4a, 4b to the second portion 10 of the connector 6 by means of the bolt joint 50 wherein a portion of the bolt joint 50 is rotated around an axis of rotation during the connection, wherein the cable terminal stopper 40a, 40b of the adapter 20 abuts the cable terminal 4a, 4b such that the cable terminal 4a, 4b assumes a predetermined rotation around the axis of rotation with respect to the connector support surface 30 when connected to the second portion 10 of the connector 6. The axis of rotation may be perpendicular to a surface of the cable terminal.

As shown for the first cable terminal 4a, as a representative of the first and second cable terminals 4a, 4b, the first cable terminal 4a is connected to the second portion 10 of the connector 6, such as to the first mating end 10a of the second portion 10 of the connector 6, by means of or via the bolt joint 50.

The rotational force applied to the bolt 46a causes the first cable terminal 4a to assume a predetermined orientation with respect to the connector support surface 30 when connected to the first mating end 10a of the second portion 10 of the connector 6. The predetermined orientation is defined by the angle formed between the plane of the cable terminal resting surface 42a and the plane of the connector support surface 30. In this way, the orientation between the cable terminal 4a and the second portion 10 of the connector 6 may be fixed in the desired manner as these components are attached to one another.

In examples herein, the adapter 20 is removable from an assembly comprising the cable terminals and the connector which are attached to one another, such that the adapter 20 can be removed from each cable terminal of the set of cable terminals and the connector when each cable terminal of the set of cable terminals and the connector have been and remain connected together. As torque is being applied to engage the first bolt 46a with the through hole in the first nut 32a to thereby attach the first cable terminal 4a to the first mating end 10a of the second portion 10 of the connector 6, the first nut 32a is lifted off of a surface of the adapter 20 such as the top surface of the nut holder 28a of the adapter 20. In this way, the assembly, comprising the first cable terminal 4a and the first mating end 10a of the second portion 10 of the connector 6, is lifted off the adapter 20 in a direction shown by a solid arrow 35 in FIG. 7. Accordingly, in examples herein, as the cable terminal is being connected to the second portion of the connector, the assembly, comprising the cable terminal and the second portion of the connector being connected together, is separated from the adapter. This may comprise lifting the bolt joint 52a off a surface of the adapter 20 such as from the surface of the nut holder 28a of the adapter 20.

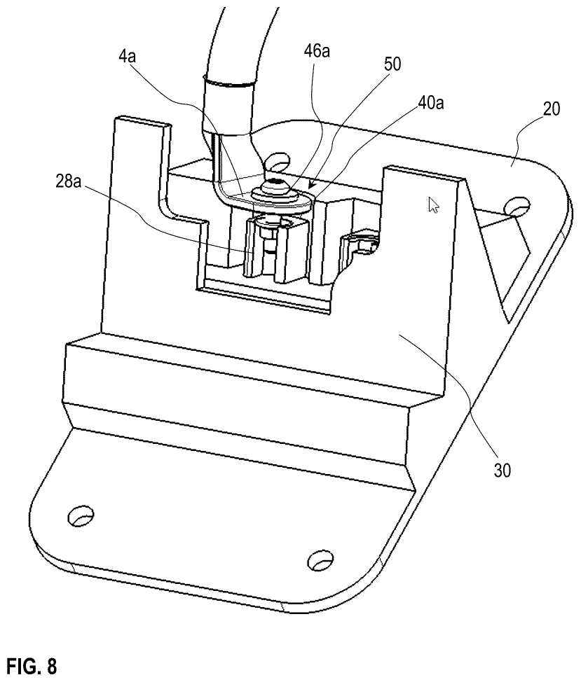

FIG. 8 additionally illustrates the first cable terminal 4a when it is secured to the connector 6, not shown in FIG. 8 for illustration purposes only, via the bolt joint 50.

The steps of the method illustrated in connection with FIGS. 5-8, comprising connecting the first cable terminal 4a and the first mating end 10a of the second portion 10 of the connector 6, may be repeated for connecting the second cable terminal 4b to the second mating end 10b of the second portion 10 of the connector 6. Thus, the second cable terminal 4b may be connected to the second portion 10 of the connector 6 wherein the second cable terminal stopper 40b of the adapter 20 abuts the second cable terminal 4b such that the second cable 4b terminal assumes the predetermined orientation with respect to the connector support surface 30 when connected to the second portion 10 of the connector 6. The second cable terminal 4b assumes a predetermined rotation around the axis of rotation with respect to the connector support surface 30 when connected to the second portion 10 of the connector 6. Thus, the first and second cable terminals 4a, 4b assume the predetermined orientation with respect to the connector support surface 30 of the adapter 20 when connected to the second portion 10 of the connector 6. In this way, each of the first and second cable terminals 4a, 4b assumes the predetermined orientation with respect to a plane of the second portion 10 of the connector 6, wherein the predetermined orientation is defined by the angle between the cable terminal resting surface plane and the connector support surface plane, which may also be defined as the angle between the cable terminal resting surface plane normal B2 and the connector support surface plane normal A2. In some examples, the angle may be 15 degrees. It should be appreciated however that the adapter 20 may be configured to allow connecting one or more cable terminals to a connector under other suitable angles.

After the first and second cable terminals 4a, 4b are attached to the second portion 10a of the connector 6, the resulting assembly can be separated from the adapter 20. As discussed above in connection with FIG. 7, as each of the cable terminals is being attached to the respective mating end of the second portion 10 of the connector 6 by engaging the bolt with the nut seated in the nut holder of the adapter, the nut with the components secured thereto is being separated from the adapter 20, such as in a direction shown by the solid arrow 35 in FIG. 7 for the first cable terminal 4a. This allows the adapter 20 to be removed from the connector 6, with the cable terminals 4a, 4b attached thereto, such as in a direction shown by a dashed arrow 45 in FIG. 7.

Accordingly, the method in accordance with examples of the present disclosure comprises removing the adapter 20 from each cable terminal 4a, 4b of the set of cable terminals 4 and the connector 6 when each cable terminal 4a, 4b of the set of cable terminals 4 and the connector 6 have been and remain connected together.

Accordingly, the adapter 20 in accordance with examples of the present disclosure allows for the cable terminal, and thus the cable comprising or attached to the cable terminal, to be connected to the connector at a desired or required angle. The angle may be required due to e.g. space constraints of an environment in which the cables and the connector are positioned. The desired orientation is achieved in a straightforward and consistent manner, without relying on expertise of a person attaching the cables and the connector, by using the adapter that facilitates establishing the connection. The adapter may be configured to facilitate a connection between one or more cable terminals and a connector under any desired angle.

After each cable terminal of the set of cable terminals and the connector have been connected together, they remain connected until a replacement of one or more of the set of cable terminals may be required. A stabilization tool or adapter in accordance with examples of the present disclosure may be used to assist in maintaining the predetermined orientation between the cable terminals and the connector such as the second portion of the connector. For example, when a cable terminal connected to the connector 6 needs to be replaced, the stabilization adapter may be used to ensure that a replacement cable terminal being connected to the connector is oriented in the same way with respect to the second portion of the connector as the previously connected cable terminal. The connector may be positioned and attached in place in an assembled vehicle. For example, as discussed above, in the vehicle, the connector 6 may be attached to the body 14 shown in FIGS. 1A and 1B. The stabilization adapter is configured so as to allow, in the assembled vehicle, connecting at least one cable terminal to the connector in the same orientation as is achieved using the adapter 20 shown in FIGS. 2-8.

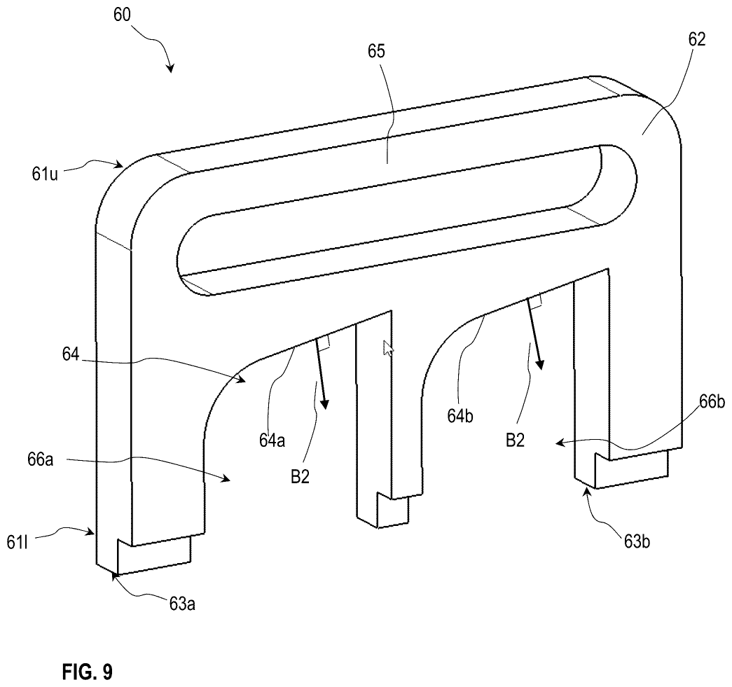

Accordingly, as shown in FIGS. 9-11, in an aspect, a stabilization adapter 60 is provided that is configured to assist in connecting at least one cable terminal of a set of cable terminals 104 to the connector e.g. connector 6 when the connector is attached to the body having the body surface, the connector 6 comprising the first portion 8 and the second portion 10 located on opposite sides of the body surface whereby the second portion 10 extends from the body surface.

In some examples, the connector may be coupled to a body having a body surface. The body may be e.g. a portion of the floor 2 of the vehicle. In some examples, the body may be a component configured to be attached to the floor 2. Thus, in some examples, the body surface may be the floor surface. As shown in FIGS. 1A and 1B, the connector 6 may be coupled to the body 14 e.g. a plate or a bracket, having the body surface 16. The body 14 may be e.g. a plate or a bracket to which the connector 6 may be connected prior to connecting the cable terminals 4a, 4b to the connector 6. In some examples, the body 14 having the body surface 16 may be a separate component. In some examples, as mentioned above, the body 14 having the body surface 16 may be part of the vehicle, e.g. a portion or part of the floor 2 of the vehicle. It should be appreciated that examples of the present disclosure are not limited to any specific configuration of the body to which the connector 6 may be coupled during the assembly of the vehicle.

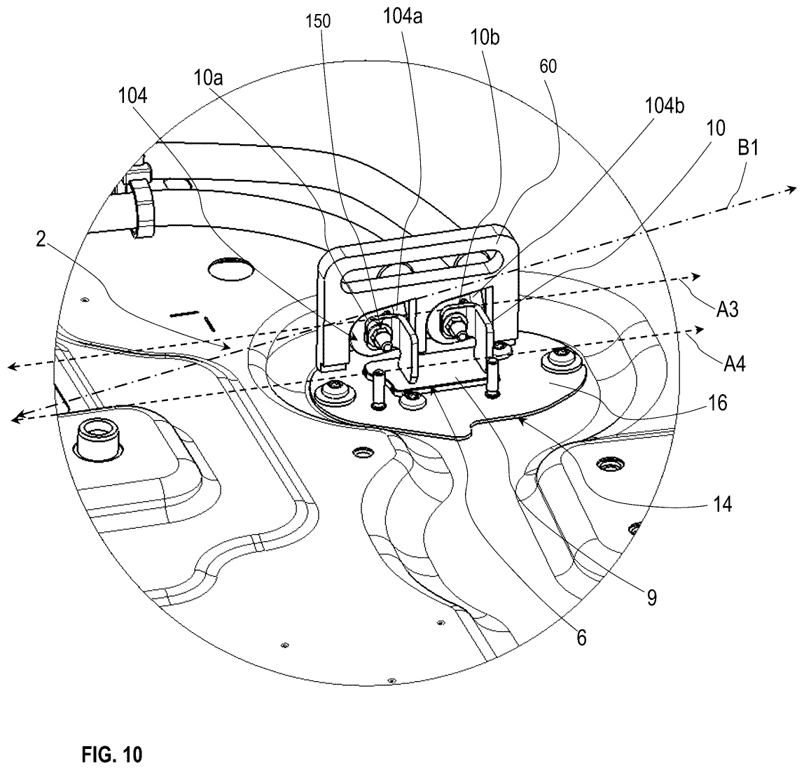

As shown in FIGS. 9, 10 and 11, the stabilization adapter 60 in accordance with examples of the present disclosure may be configured to assist in connecting at least one cable terminal 104a, 104b of a set of cable terminals 104 to the connector 6 when the connector 6 is attached to the body 14 having the body surface 16. The set of cable terminals 104 are numbered differently from the set of cable terminals 4, shown in FIGS. 1A-1B and also in FIGS. 5-8 as the first cable terminal 4a, to illustrate that different e.g. replacement cable terminal(s) may be connected to the connector 6 after at least one of the set of cable terminals 4 has been disconnected from the connector 6. It should be appreciated that the set of cable terminals 104 comprising at least one cable terminal, e.g. first and second cable terminals 104a, 104b, may be similar or the same as the set of cable terminals 4 of FIGS. 1A-1B. Also, the cable terminals connected to the connector can be replaced one by one, such that the connector 6 may have one of the set of cable terminals 4 of FIGS. 1A-1B and one of the set of cable terminals 104 of FIGS. 9-10 connected thereto.

FIG. 9 illustrates an example of the stabilization adapter 60 in accordance with an example of the present disclosure. The stabilization adapter 60 is adapted to at least partially accommodate the second portion 10 of the connector 6 and/or to contact at least a portion of the body surface 16. As shown in FIG. 9, the stabilization adapter 60 comprises a body 62 having a lower portion 61l and an upper portion 61u, wherein the lower portion 61l is configured to be positioned against the body surface 16 to which the connector 6 is attached. For example, as shown in FIG. 9, the lower portion 61l may comprise first and second support surfaces 63a, 63b on a bottom surface of the stabilization adapter 60, wherein the first and second support surfaces 63a, 63b are configured to contact at least a portion of the body surface 16 during use of the stabilization adapter 60.

The stabilization adapter 60 e.g. the stabilization adapter body 62 comprises at least one cable terminal stopper 64 for at least one cable terminal of the set of cable terminals. The cable terminal stopper 64 is configured to abut the cable terminal during connection of the cable terminal to the second portion 10 of the connector 6 such that the cable terminal assumes a predetermined orientation with respect to the body surface 16 when connected to the second portion 10 of the connector 6 and with respect to the second portion 10 of the connector 6. The predetermined orientation is defined by an angle formed between a plane passing through a surface of the cable terminal stopper 64 and a plane passing through a surface of the second portion 10 of the connector 6, which is shown in FIG. 10 as a dot-dashed axis B1 indicating a longitudinal direction of a plane passing through a surface of the cable terminal stopper 64 and a dashed axis A4 indicating the longitudinal direction of the second portion 10 of the connector 6. It should be appreciated that planes passing through some parts of the second portion 10 of the connector 6 may be parallel to one another, and it is the angle between these planes and a plane passing through a surface of at least one cable terminal that can be assured using the adapter 20 and the stabilization adapter 60. Thus, a plane passing through the support surface or plate 9, having a longitudinal direction A4 which is parallel to the longitudinal direction of the plane passing through the body surface 16, may be parallel to a plane passing through top surfaces of the first and second mating ends 10a, 10b of the second portion 10 of the connector. Thus, as shown in FIG. 10, the axis A3, indicating the longitudinal direction of the plane passing through the top surfaces of the first and second mating ends 10a, 10b, may be parallel to the axis A4 indicating the longitudinal direction of the plane of the support surface or plate 9.

The angle between the axis B1 indicating the longitudinal direction of the plane of the cable terminal stopper 64 and each of the axes A3, A4 may be the same as the angle formed between the cable terminal resting surface plane and the connector support surface plane shown in FIGS. 2 and 3. In some examples, the angle may be 15 degrees, though other angles are possible depending on a configuration of the adapter 20 and the respective stabilization adapter 60. In other words, the stabilization adapter 60 may be configured to establish the same angle between the plane of the at least one cable terminal and the plane of at least the second portion 10 of the connector 6 as was established using the adapter 20. The plane of at least the second portion 10 of the connector 6 may comprise one or more planes parallel to one another, such as one or more of the plane passing through the top surfaces of the first and second mating ends 10a, 10b, the plane of the support surface or plate 9, and the plane of the body surface 16.

As shown in FIG. 9, the at least one cable terminal stopper 64 may comprise first and second cable terminal stoppers 64a, 64b configured to abut respective cable terminals when the stabilization adapter 60 is applied for connecting at least one cable terminal to the connector 6. The first and second cable terminal stoppers 64a, 64b may be sized and shaped to abut the first and second cable terminals 104a, 104b, respectively. The first and second cable terminal stoppers 64a, 64b may comprise respective cable terminal resting surfaces each of which extends in a cable terminal resting surface plane with a cable terminal resting surface plane normal B2.

As shown in FIG. 9, the first and second cable terminal stoppers 64a, 64b may be formed by surfaces of inner walls of respective first and second cutouts 66a, 66b formed in the body 62 of the stabilization adapter 60. The first and second cutouts 66a, 66b may extend from a bottom of the stabilization adapter body 62 such as from the lower portion 61l and towards the upper portion 61u. It should be appreciated that the lower and upper portions 61l, 61u are referred as such for description purposes only, to demonstrate that one side of the stabilization adapter 60 can be positioned closer to the second portion of the connector and/or to contact at least a portion of the body surface, whereas another side can be held by a person. There may be no defined boundary between the lower and upper portions 61l, 61u of the stabilization adapter 60.

As shown in FIG. 9, the upper portion 61u of the stabilization adapter 60 may be configured to be held by a person and the upper portion 61u may have optional features that facilitate grip. For example, as shown in FIG. 9, the stabilization adapter 60 may comprise a handle 65 or another gripping feature formed in the upper portion 61u of the body 62 of the stabilization adapter 60. The handle 65 is an optional feature and other types of features may be used. For example, a surface of the upper portion 61u may comprise ridges, ribs, extensions, or other elements that facilitate a person holding the stabilization adapter 60 against a surface without displacement. After use, the stabilization adapter 60 may be lifted off and thereby removed from the connector and the at least one cable terminal that has been attached to the connector.

Regardless of a specific configuration of the stabilization adapter 60, it may be configured such that it can be held by a single person, and in some cases by one hand of a single person. The stabilization adapter 60 is such that it can be removed from the at least one cable terminal of the set of cable terminals 104 and the second portion 10 of the connector 6 when the at least one cable terminal of the set of cable terminals and the connector 6 have been and remain connected together. Accordingly, the stabilization adapter 60 is configured to be easily used by a person during repair or maintenance which may involve replacement of one or more cable terminals connected to a connector.

It should be appreciated that the configuration of the stabilization adapter 60 as shown in FIG. 9 is an example configuration, as other configurations are possible. Nevertheless, in any of the configurations, the stabilization adapter comprises a cable terminal stopper for the at least one cable terminal of the set of cable terminals, the cable terminal stopper being configured to abut the cable terminal during connection of the cable terminal to the second portion of the connector such that the cable terminal assumes a predetermined orientation with respect to the body surface when connected to the second portion of the connector. Also, the stabilization adapter is such that it can be removed from the at least one cable terminal of the set of cable terminals and the second portion of the connector when the at least one cable terminal and the connector have been and remain connected together.

The stabilization adapter 60 may be made from any suitable material and it is sufficiently rigid to perform the stabilization function. Parts of the stabilization adapter 60 may be monolithically and/or integrally formed with one another. In some examples, the stabilization adapter 60 may be made by injection molding from a suitable polymer material. In some examples, the stabilization adapter 60 may be made from a metal.

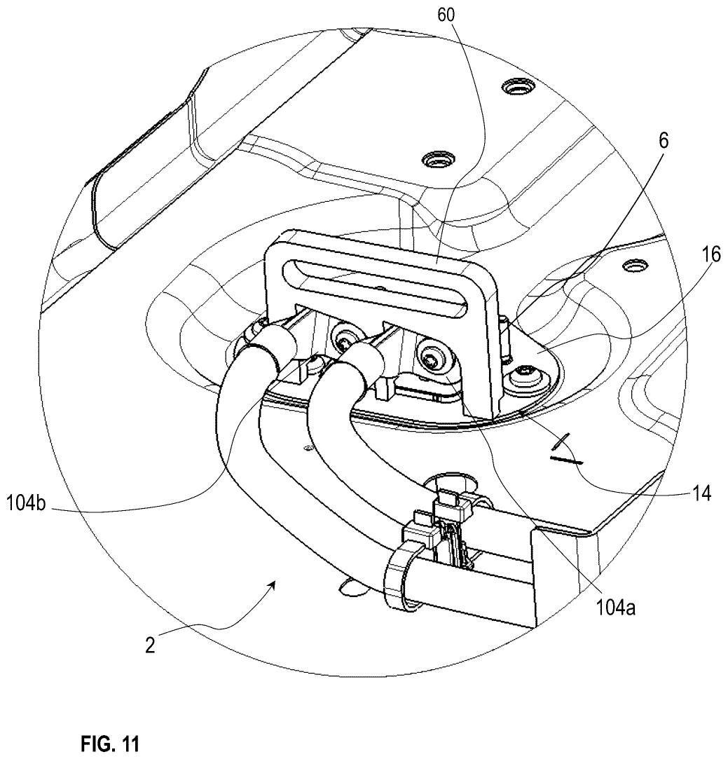

FIGS. 10 and 11 illustrate an example of use of the stabilization adapter 60 of FIG. 9 in a vehicle e.g. in the same environment as shown in FIGS. 1A and 1B. The stabilization adapter 60 may be used in a method for connecting at least one cable terminal of a set of cable terminals to a connector using the stabilization adapter, e.g., at least one cable terminal of the set of cable terminals 104 to the connector 6. In FIGS. 10 and 11, each cable terminal 104a, 104b of the set of cable terminals 104 is adapted to be connected to the second portion 10 of the connector 6 by means of a bolt joint 150 which may be similar to bolt joint 50 shown in FIGS. 7 and 8 used to connect the cable terminal 4a of the set of cable terminals 4 to the second portion 10 of the connector 6.

As shown in FIG. 10, the method comprises positioning the stabilization adapter 60 whereby the stabilization adapter 60 at least partially accommodates the second portion 10 of the connector 60 and/or contacts at least a portion of the body surface 16. In some implementations, the stabilization adapter 60 may be positioned so that it does not contact the second portion 10 of the connector 6. Positioning the stabilization adapter 60 may comprise positioning the stabilization adapter 60 over the connector 6. In some cases, the connector 6 may be connected to one or more cable terminals 104, wherein at least one cable terminal of the cable terminals 104 may be not connected to the connector 6 when the stabilization adapter 60 is being used. As shown in FIG. 10, the stabilization adapter 60 may be positioned relative to the connector 6 such that the first and second cable terminal stoppers 64a, 64b abut the respective first and second cable terminals 104a, 104b. It should be noted that, even though both of the first and second cable terminals 104a, 104b are shown in FIGS. 10 and 11, one or both of them may not be connected to the connector when the stabilization adapter 60 is used. Indeed, the stabilization adapter 60 is used to position at least one cable terminal of the first and second cable terminals 104a, 104b in a predetermined orientation relative to the second portion 10 of the connector 6 when the at least one cable terminal is being connected to the second portion 10 of the connector 6.

The method also comprises removing the stabilization adapter 60 from the at least one cable terminal of the set of cable terminals 104 and the connector 6 when the at least one cable terminal of the set of cable terminals 104 and the connector 6 have been and remain connected together.

As discussed above, the stabilization adapter 60 is configured so as to allow to connect the at least one cable terminal 104a, 104b to the connector 6 in the desired or required orientation which is the same orientation at which cable terminals can be connected to the connector 6 using the adapter 20 shown in FIGS. 2-8. In this way, the stabilization adapter 60 performs a similar function to the adapter 20 as the stabilization adapter 60 allows connecting a cable terminal to the connector so as to establish a required orientation between the cable terminal and at least a second portion of the connector, wherein the orientation is required due to certain space constraints and components positioning in a vehicle or in another application.

Below follows a number of Examples which may respectively be combined with any of the other examples herein.

### EXAMPLES

Example 1. An adapter (20) configured to assist in connecting each cable terminal (4a, 4b) of a set of cable terminals (4) to a connector (6), the connector (6) comprising a first portion (8) and a second portion (10),
the adapter (20) comprising a connector support surface (30) configured to support the first portion of the connector when the adapter accommodates the connector such that the first and second portions of the connector are positioned on opposite sides of the connector support surface (30), the adapter being such that each cable terminal (4a, 4b) of the set of cable terminals (4) can be connected to the second portion of the connector when the adapter accommodates the connector such that the first and second portions of the connector are positioned on opposite sides of the connector support surface (30);
   the adapter (20) comprising a cable terminal stopper (40a, 40b) for each cable terminal (4a, 4b) of the set of cable terminals (4), the cable terminal stopper (40a, 40b) being configured to abut the cable terminal during connection of the cable terminal to the second portion of the connector such that the cable terminal assumes a predetermined orientation with respect to the connector support surface (30) when connected to the second portion of the connector, and
   the adapter (20) being such that it can be removed from each cable terminal of the set of cable terminals and the connector when each cable terminal of the set of cable terminals and the connector have been and remain connected together.

Example 2. The adapter (20) of Example 1, wherein the connector support surface (30) extends in a connector support surface plane having a connector support surface plane normal (A2), wherein each cable terminal stopper comprises a cable terminal resting surface (42a, 42b), the cable terminal resting surface (42a, 42b) being configured to abut the cable terminal during connection of the cable terminal to the second portion of the connector, the at least one cable terminal resting surface being located at a distance from the connector support surface (30) in a direction parallel to the connector support surface plane normal, the at least one cable terminal resting surface (42a, 42b) extending in a cable terminal resting surface plane with a cable terminal resting surface plane normal (B2), the cable terminal resting surface plane normal forming an angle with the connector support surface plane normal.

Example 3. The adapter (20) of Example 1 or Example 2, wherein each cable terminal of the set of cable terminals is adapted to be connected to the second portion of the connector by means of a bolt joint (50) when the first and second portions of the connector are positioned on opposite sides of the connector support surface (30).

Example 4. The adapter (20) of any one of the preceding Examples, wherein a portion of the bolt joint (50) is adapted to be rotated around an axis of rotation during the connection, wherein the cable terminal stopper (40a, 40b) of the adapter (20) abuts the cable terminal such that the cable terminal assumes a predetermined rotation around the axis of rotation with respect to the connector support surface (20) when connected to the second portion of the connector.

Example 5. The adapter (20) of Example 3 or Example 4, further comprising:
at least one nut holder (28a, 28b) for each cable terminal of a set of cable terminals, the nut holder (28a, 28b) being adapted to hold a nut (32a, 32b) forming part of the bolt joint (50), before the first and second portions of the connector are positioned on opposite sides of the connector support surface (30).

Example 6. A use of the adapter (20) of any one of the preceding Examples for connecting each cable terminal (4a, 4b) of a set of cable terminals (4) to a connector (6).

Example 7. A method for connecting each cable terminal of a set of cable terminals to a connector using an adapter (20), the connector comprising a first portion and a second portion, the method comprising:
inserting the connector in the adapter whereby the first and second portions of the connector are located on opposite sides of a connector support surface of the adapter;
for each cable terminal of the set of cable terminals:
   connecting the cable terminal to the second portion of the connector wherein a cable terminal stopper of the adapter abuts the cable terminal such that the cable terminal assumes a predetermined orientation with respect to the connector support surface when connected to the second portion of the connector; and
removing the adapter from each cable terminal of the set of cable terminals and the connector when each cable terminal of a set of cable terminals and the connector have been and remain connected together.

Example 8. The method of Example 7, wherein the method comprises the following for each cable terminal of the set of cable terminals:
connecting the cable terminal to the second portion of the connector by means of a bolt joint wherein a portion of the bolt joint is rotated around an axis of rotation during the connection, wherein the cable terminal stopper of the adapter abuts the cable terminal such that the cable terminal assumes a predetermined rotation around the axis of rotation with respect to the connector support surface when connected to the second portion of the connector.

Example 9. A stabilization adapter (60) configured to assist in connecting at least one cable terminal (104a, 104b) of a set of cable terminals (104) to a connector (6) when the connector (6) is attached to a body (2, 14) having a body surface (16), the connector (6) comprising a first portion (8) and a second portion (10) located on opposite sides of the body surface (16) whereby the second portion (10) extends from the body surface (16),
the stabilization adapter (60) being adapted to at least partially accommodate the second portion (10) of the connector and/or to contact at least a portion of the body surface (16);
the stabilization adapter (60) comprising a cable terminal stopper (64a, 64b) for the at least one cable terminal of the set of cable terminals (104), the cable terminal stopper (64a, 64b) being configured to abut the cable terminal (104a, 104b) during connection of the cable terminal to the second portion (10) of the connector (6) such that the cable terminal (104a, 104b) assumes a predetermined orientation with respect to the body surface (16) when connected to the second portion (10) of the connector,
the stabilization adapter (60) being such that it can be removed from the at least one cable terminal of the set of cable terminals (104) and the second portion (10) of the connector when the at least one cable terminal (104a, 104b) of the set of cable terminals (104) and the connector (6) have been and remain connected together.

Example 10. A use of the stabilization adapter (60) of Example 9 for connecting at least one cable terminal (104a, 104b) of a set of cable terminals (104) to a connector (6).

Example 11. A method for connecting at least one cable terminal of a set of cable terminals (104) to a connector (6) using a stabilization adapter (60), the connector being attached to a body (2, 14) having a body surface (16), the connector (6) comprising a first portion (8) and a second portion (10) located on opposite sides of the body surface whereby the second portion extends from the body surface, the method comprising:
positioning the stabilization adapter whereby the stabilization adapter at least partially accommodates the second portion and/or contacts at least a portion of the body surface;
for the at least one cable terminal of the set of cable terminals:
   connecting the at least one cable terminal to the second portion of the connector wherein a cable terminal stopper of the stabilization adapter abuts the at least one cable terminal such that the at least one cable terminal assumes a predetermined orientation with respect to the body surface when connected to the second portion of the connector; and
removing the stabilization adapter from the at least one cable terminal of the set of cable terminals and the connector when the at least one cable terminal of the set of cable terminals and the connector have been and remain connected together.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the inventive concepts being set forth in the following claims.

What is claimed is:

1. An adapter configured to assist in connecting each cable terminal of a set of cable
terminals to a connector, the connector comprising a first portion and a second portion,
the adapter comprising a connector support surface configured to support the first portion of the connector when the adapter accommodates the connector such that the first and second portions of the connector are positioned on opposite sides of the connector support surface, the adapter being such that each cable terminal of the set of cable terminals can be connected to the second portion of the connector when the adapter accommodates the connector such that the first and second portions of the connector are positioned on opposite sides of the connector support surface;
the adapter comprising a cable terminal stopper for each cable terminal of the set of cable terminals, the cable terminal stopper being configured to abut the cable terminal during connection of the cable terminal to the second portion of the connector such that the cable terminal assumes a predetermined orientation with respect to the connector support surface when connected to the second portion of the connector, and
the adapter being such that it can be removed from each cable terminal of the set of cable terminals and the connector when each cable terminal of the set of cable terminals and the connector have been and remain connected together.

2. The adapter of claim 1, wherein the connector support surface extends in a connector support surface plane having a connector support surface plane normal, wherein each cable terminal stopper comprises a cable terminal resting surface, the cable terminal resting surface being configured to abut the cable terminal during connection of the cable terminal to the second portion of the connector, the at least one cable terminal resting surface being located at a distance from the connector support surface in a direction parallel to the connector support surface plane normal, the at least one cable terminal resting surface extending in a cable terminal resting surface plane with a cable terminal resting surface plane normal, the cable terminal resting surface plane normal forming an angle with the connector support surface plane normal.

3. The adapter of claim 1, wherein each cable terminal of the set of cable terminals is adapted to be connected to the second portion of the connector by means of a bolt joint when the first and second portions of the connector are positioned on opposite sides of the connector support surface.

4. The adapter of claim 3, wherein a portion of the bolt joint is adapted to be rotated around an axis of rotation during the connection, wherein the cable terminal stopper of the adapter abuts the cable terminal such that the cable terminal assumes a predetermined rotation around the axis of rotation with respect to the connector support surface when connected to the second portion of the connector.

5. The adapter of claim 3, further comprising:
at least one nut holder for each cable terminal of a set of cable terminals, the nut holder being adapted to hold a nut forming part of the bolt joint, before the first and second portions of the connector are positioned on opposite sides of the connector support surface.

6. A use of the adapter of claim 1 for connecting each cable terminal of a set of cable terminals to a connector.

7. A method for connecting each cable terminal of a set of cable terminals to a connector using an adapter, the connector comprising a first portion and a second portion, the method comprising:
inserting the connector in the adapter whereby the first and second portions of the connector are located on opposite sides of a connector support surface of the adapter;
for each cable terminal of the set of cable terminals:
connecting the cable terminal to the second portion of the connector wherein a cable terminal stopper of the adapter abuts the cable terminal such that the cable terminal assumes a predetermined orientation with respect to the connector support surface when connected to the second portion of the connector; and
removing the adapter from each cable terminal of the set of cable terminals and the connector when each cable terminal of a set of cable terminals and the connector have been and remain connected together.

8. The method of claim 7, wherein the method comprises the following for each cable terminal of the set of cable terminals:
connecting the cable terminal to the second portion of the connector by means of a bolt joint wherein a portion of the bolt joint is rotated around an axis of rotation during the connection, wherein the cable terminal stopper of the adapter abuts the cable terminal such that the cable terminal assumes a predetermined rotation around the axis of rotation with respect to the connector support surface when connected to the second portion of the connector.

9. A stabilization adapter configured to assist in connecting at least one cable terminal of a set of cable terminals to a connector when the connector is attached to a body having a body surface, the connector comprising a first portion and a second portion located on opposite sides of the body surface whereby the second portion extends from the body surface,
the stabilization adapter being adapted to at least partially accommodate the second portion of the connector and/or to contact at least a portion of the body surface;
the stabilization adapter comprising a cable terminal stopper for the at least one cable terminal of the set of cable terminals, the cable terminal stopper being configured to abut the cable terminal during connection of the cable terminal to the second portion of the connector such that the cable terminal assumes a predetermined orientation with respect to the body surface when connected to the second portion of the connector,
the stabilization adapter being such that it can be removed from the at least one cable terminal of the set of cable terminals and the second portion of the connector when the at least one cable terminal of the set of cable terminals and the connector have been and remain connected together.

10. A use of the stabilization adapter of claim 9 for connecting at least one cable terminal of a set of cable terminals to a connector.

11. A method for connecting at least one cable terminal of a set of cable terminals to a connector using a stabilization adapter, the connector being attached to a body having a body surface, the connector comprising a first portion and a second portion located on opposite sides of the body surface whereby the second portion extends from the body surface, the method comprising:
positioning the stabilization adapter whereby the stabilization adapter at least partially accommodates the second portion and/or contacts at least a portion of the body surface;
for the at least one cable terminal of the set of cable terminals:
connecting the at least one cable terminal to the second portion of the connector wherein a cable terminal stopper of the stabilization adapter abuts the at least one cable terminal such that the at least one cable terminal assumes a predetermined orientation with respect to the body surface when connected to the second portion of the connector; and
removing the stabilization adapter from the at least one cable terminal of the set of cable terminals and the connector when the at least one cable terminal of the set of cable terminals and the connector have been and remain connected together.
